(19) United States
(12) Patent Application Publication
(10) Pub. No.: US 2026/0080209 A1
(43) Pub. Date: Mar. 19, 2026

(54) SYSTEM TO REDUCE MULTI-MODAL EMBEDDING DIMENSIONS

(71) Applicant: Schlumberger Technology Corporation, Sugar Land, TX (US)

(72) Inventors: Omkar Anil Gune, Pune (IN); Purnaprajna Mangsuli, Pune (IN)

(21) Appl. No.: 19/328,726

(22) Filed: Sep. 15, 2025

(30) Foreign Application Priority Data
Sep. 13, 2024 (IN) 202411069446

(51) Int. Cl. G06N 3/042; G06N 3/0455; G06N 3/08

(52) U.S. Cl. CPC G06N 3/042; G06N 3/0455; G06N 3/08

(57) ABSTRACT

A large language model (LLM) generates a synthetic query. A first-dimensional embedding model generates a query embedding of the synthetic query. A training dataset of first-dimensional embeddings, within a similarity threshold of the query embedding is retrieved. An auto-encoder is trained with the training dataset. The auto-encoder includes an input layer, a bottleneck encoder layer, and a decoder layer. A second-dimensional embedding model, including the first-dimensional embedding model, and the bottleneck encoder layer of the auto-encoder, is configured. An output of the first-dimensional embedding model is connected to an input of the bottleneck encoder layer, to obtain the second-dimensional embedding model. The second-dimensional embedding model is used to generate second-dimensional embeddings having a second dimension. The second dimension is lower than the first dimension.

### CROSS REFERENCE TO RELATED APPLICATIONS

This application claims benefit to India Application No. 202411069446, filed in India on Sep. 13, 2024, and which is incorporated herein by reference.

### BACKGROUND

Large language models (LLMs) are used in various domains and contexts in the oil and gas industry. Some LLMs use retrieval-augmented-generation (RAG), in which an LLM may search and access document corpora of enterprises and use the results for generative natural language output. Notably, the LLMs may not be trained on these document corpora. RAG techniques facilitate the integration and use of commercially available LLMs into esoteric domains, without the need for extensive re-training of the LLMs.

When LLMs use RAG for generative output, the document corpora to be searched is to be converted to embeddings. Embeddings are vector representations of the content of document corpora. The content of the document corpora may be in diverse formats, such as text, images, audio, video, etc. Vector representations, that is, embeddings, render the content of the document corpora into a machine-readable and understandable form, on which various operations such as search, comparison, and generative output may be performed. As the volume and diversity of the document corpora increase, the computational resources required to store and manage embeddings may increase proportionally. Reducing the dimensions of embeddings may reduce the requirement of computational resources, however, the accuracy of search and retrieval may be compromised.

### SUMMARY

In general, a large language model (LLM) generates a synthetic query. A first-dimensional embedding model generates a query embedding of the synthetic query. A training dataset of first-dimensional embeddings, within a similarity threshold of the query embedding is retrieved. An auto-encoder is trained with the training dataset. The auto-encoder includes an input layer, a bottleneck encoder layer, and a decoder layer. A second-dimensional embedding model, including the first-dimensional embedding model, and the bottleneck encoder layer of the auto-encoder, is configured. An output of the first-dimensional embedding model is connected to an input of the bottleneck encoder layer, to obtain the second-dimensional embedding model. The second-dimensional embedding model is used to generate second-dimensional embeddings having a second dimension. The second dimension is lower than the first dimension.

Other aspects of one or more embodiments will be apparent from the following description and the appended claims.

### BRIEF DESCRIPTION OF DRAWINGS

FIG. 1 shows a diagram of a system in accordance with one or more embodiments.

FIG. 2, FIG. 3.1, and FIG. 3.2 show flowcharts in accordance with one or more embodiments.

FIG. 4, FIG. 5, FIG. 6, and FIG. 7 show example diagrams in accordance with one or more embodiments.

FIG. 8.1 and FIG. 8.2 show a computing system in accordance with one or more embodiments.

Like elements in the various figures are denoted by like reference numerals for consistency.

### DETAILED DESCRIPTION

In general, embodiments are directed to reducing the dimensionality of embeddings for faster latency and reduced memory requirements while retaining the semantics of the embeddings. Specifically, embodiments reduce embedding dimensions of multi-modal document chunks in retrieval augmented generation (RAG) frameworks. Retrieval augmented generation (RAG) frameworks are frameworks for deploying pre-trained large language models (LLMs) on computing platforms serving thousands of clients via enterprise applications. In a RAG framework, the answer generation process of LLMs is augmented with additional reference documents or passages from external information sources. The external information sources may encompass an enterprise's proprietary knowledge bases, content stores, databases, etc. The LLM uses the reference documents or passages and its individual knowledge base to generate a better-informed response to the prompt. Notably, the LLM may not be trained on the external information sources.

In a RAG framework, unstructured data in the form of documents encompassing text, images, graphical artifacts such as tables, graphs, charts, etc., is converted into vector embeddings and stored in vector databases (VDBs). Vector embeddings are machine-understandable representations of textual, image, and graphical artifact data of a document. Vector embeddings may be subjected to mathematical operations by machine learning models deployed in enterprise computing systems for search, analysis, and insights on the underlying data. Vector embeddings may be stored in the form of high-dimensional vectors, for example, 4096 dimensionality.

The system initially obtains documents from an unstructured data store and clusters the documents using a clustering model. A limited sample of the clustered documents are obtained and chunked by a document retriever. The document chunks may include multi-modal data, for example, textual data, image data, graphical artifact (tables, charts, graphs) data. A high-dimensional embedding model processes the document chunks to generate high-dimensional embeddings. The high-dimensional embeddings are stored in an in-memory vector database. In a subsequent workflow, the vector embeddings from the in-memory vector database (VDB) are used to train an auto-encoder. The trained auto-encoder may have one or more encoder layers that encode the vector embeddings into a low-dimensional form. The encoder layer(s) of the trained auto-encoder is used in building a low-dimensional embedding model.

The low-dimensional embedding model is further used to process the documents from the unstructured data store and generate low-dimensional embeddings. The low-dimensional embeddings are stored in a vector database in a data repository.

The vector database of low-dimensional embeddings is used in the RAG framework to obtain additional information for the LLM while processing a user prompt.

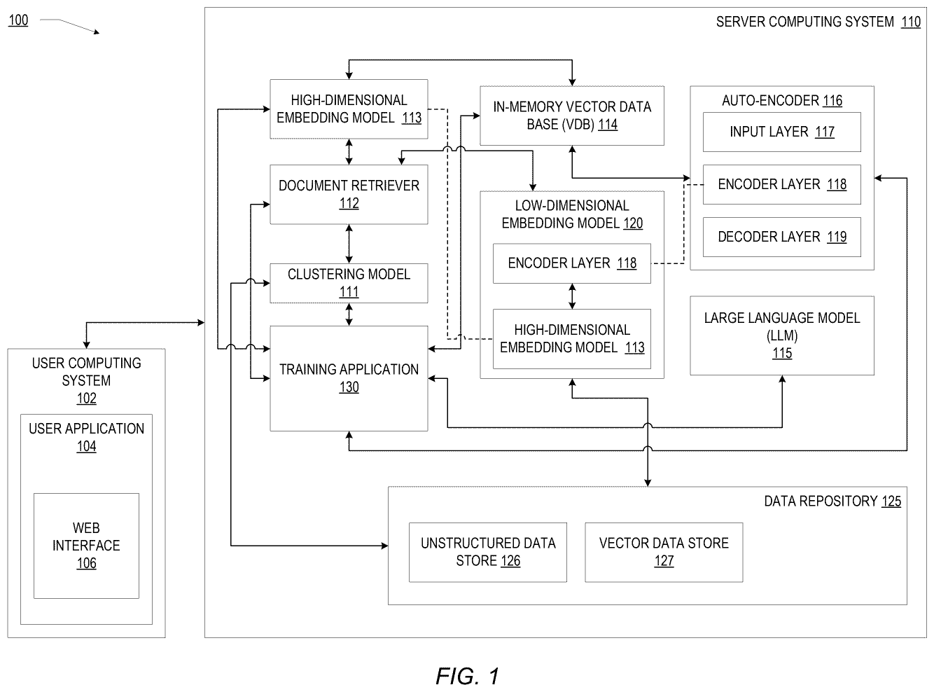

FIG. 1 is a diagram of an example system (100) in accordance with one or more embodiments. As shown in FIG. 1, a server computing system (110) is operably and communicably connected to a user computing system (102). Each of these components are described below.

The user computing system (102) is one or more computer processors, data repositories, communication devices, and supporting hardware and software. The user computing system (102) may be in a distributed computing environment. The user computing system (102) includes one or more user applications (104). Some examples of user applications (104) may include enterprise-level knowledge base systems, search portals, etc. The user application (104) may include a web interface (106). A user may interact with the user application (104) via the web interface (106). The user application (104) may provide access to a user of a retrieval augmented generation framework.

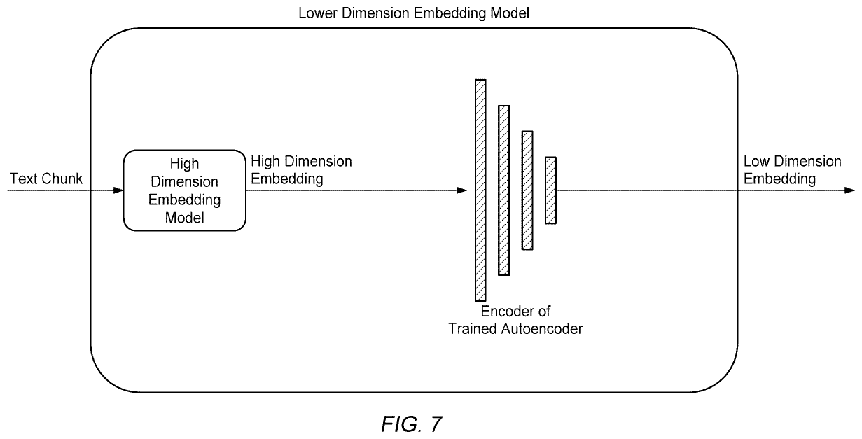

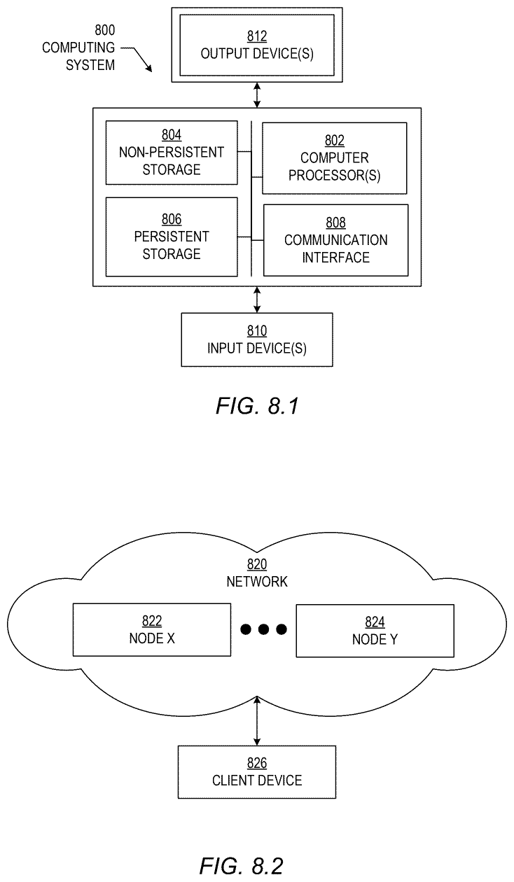

The server computing system (110) is one or more computer processors, data repositories, communication devices, and supporting hardware and software. The server computing system (110) may be in a distributed computing environment. The one or more computer processors of the server computing system (110) is one or more hardware or virtual processors which may execute computer readable program code that defines one or more applications. The one or more applications may include the clustering model (111), the document retriever (112), the high-dimensional embedding model (113), the in-memory vector database (114), the large language model (LLM) (115), the autoencoder (116), the low-dimensional embedding model (120), and the training application (130). An example of the computer processor is described with respect to the computer processor(s) (802) of FIG. 8.1. An example of a computer system and network that may form the server computing system (110) is described with respect to FIG. 8.1 and FIG. 8.2.

The server computing system (110) further includes a data repository (125). The data repository (125) is a type or storage unit or device (e.g., a file system, database, data structure, or any other storage mechanism), for storing data. The data repository (125) may include multiple different, potentially heterogeneous, storage units and/or physical storage devices. The data repository (125) includes an unstructured data store (126). The unstructured data store (126) includes one or more document stores, encompassing the document corpora of an enterprise. The documents may include multi-modal data, for example, textual data, image data, graphical artifact data such as tables, charts, graphs, etc.

The data repository (125) further includes a vector data store (127). The vector data store (127) is a specialized data store designed to store and manage vector embeddings that are numerical representations of multi-modal data of a document. The vector data store (127) may be used for text and image retrieval. Examples of vector data stores (127) may include Pinecone®, Elastic®, etc. The vector data store (127) may also be referred to as a “vector database”.

The server computing system (110) includes a clustering model (111). The clustering model (111) is an unsupervised machine learning model, configured to obtain documents from the unstructured data store (126) as input and cluster the documents using a clustering algorithm. In one or more embodiments, the clustering algorithm may be K-means clustering. In one or more embodiments, the clustering model (111) may be a custom clustering model built using TensorFlow and PyTorch libraries. Alternatively, an example of an off-the-shelf clustering model handling multi-modal document data is the Multi-modal Deep clustering (MMDC) framework. In one or more embodiments, the document clusters generated by the clustering model (111) may be stored in the data repository (125) (not shown).

The server computing system (110) includes a document retriever (112). The document retriever (112) is a collection of programs and code, configured to retrieve documents and document chunks from document clusters in the data repository (125). A document chunk is a smaller segment of a larger document, extracted for manageable processing and analysis. Document chunks may be extracted based on fixed sizes, or natural segments, for example, paragraphs under a section heading. A document chunk may retain enough context to be meaningful per se. Document retrievers that can retrieve document chunks from multi-modal documents are known as multi-vector retrievers. One example of a multi-vector retriever the multi-vector retriever from the open source framework LangChain.

The server computing system (110) includes a high-dimensional embedding model (113). As a general overview, embeddings generated for text may entail vector representations of 300 dimensions (for example, Word2Vec), or 768 dimensions (for example, Bidirectional Encoder Representations from Transformers (BERT)), or 1024 dimensions (for example, Mistral Embed®). Vector representations of 4096 dimensions may be used in specialized applications in the domain of high-resolution image analysis, complex document embeddings, or multi-modal data integration. Accordingly, in one or more embodiments, the high-dimensional embedding model (113) may be configured to generate embeddings of around 2048 dimensions to around 4096 dimensions. Dimensions of this scale may capture the characteristics of multi-modal data. Other ranges may be possible. One example of a high-dimensional multi-modal embedding model is the Multi-modal Generative Embedding Model (MM-GEM).

The server computing system (110) includes an in-memory vector database (VDB) (114). The in-memory VDB (114) is a specialized type of database configured to store and manage vector embeddings directly in system memory, in contrast to databases in a data repository. By being resident in system memory, in-memory VDBs provide low latency (real-time or near real-time) processing and performance. Examples of in-memory VDBs include Vemcache, SharpVector, etc.

The server computing system includes an LLM (115). The LLM (115) may be part of the RAG framework deployed in the server computing system (110). In one or more embodiments, the LLM (115) may be a commercially available LLM, for example, ChatGPT® from OpenAI, Llama®, Claude®, Mistral-7B®, etc. In other embodiments, the LLM (115) may be a custom-built LLM, including a foundation model and additional customizing implementation. Foundation models are large artificial intelligence (AI) models trained on broad data, serving as base models for generative AI systems, such as LLMs. As a general overview, LLMs provide natural language responses to natural language utterances. A natural language utterance is one or more phrases and/or sentences expressed in a way that is characteristic of human communication. A prompt is a natural language utterance provided to an LLM. In one or more embodiments, document chunks obtained from the document clusters in the data repository may be provided to the LLM (115) by the training application (130) with an instruction to generate a synthetic query based on the document chunk(s). The LLM (115) may generate the synthetic query, which may be further used to train the auto-encoder ().

The server computing system (110) further includes an auto-encoder (116). The auto-encoder (116) includes an input layer (117), an encoder layer (118) and a decoder layer (119). The auto-encoder (116) is an unsupervised machine learning model. The auto-encoder may use an artificial neural network to learn efficient representations (low-dimensional representations) of input data while preserving the characteristics of the input data. The auto-encoder (116) includes input layers, encoding layers, and decoding layers. The input layers capture incoming high-dimensional embeddings to the auto-encoder and output the embeddings to the encoder layer. The encoder layer converts the high-dimensional embeddings into a low-dimensional representation. Thus, the encoder layer is referred to as the latent space layer or “bottleneck” layer. The decoder layer reconstructs the original data from the low-dimensional representation generated by the encoder layer. The auto-encoder is trained to minimize the difference between the input data and the reconstructed data, by using a loss function. In one or more embodiments, the auto-encoder may be trained in accordance with a triplet loss algorithm. In minimizing the difference between the reconstructed data and the input data, the hyperparameters of the encoder layer may be updated, by back propagation or other means. Thus, in training the auto-encoder, the encoder layer learns to convert the input data into a low-dimensional representation while conserving the characteristics of the input data. In one or more embodiments, the low dimension may be less than the high dimension by at least 50%.

Accordingly, the input layer (117) of the auto-encoder (116) takes incoming high-dimensional embeddings and outputs the embeddings to the encoder layer (118). The encoder layer (118) converts the high-dimensional embeddings to low-dimensional embeddings. In one or more embodiments, the dimension reduction of the embeddings may be around at least 50%. For example, a 2048 dimensional embedding may be converted to a 1024 dimensional embedding by the encoder layer (118). Other dimensionality reductions, for example, by about 75% are possible. The decoder layer (119) reconstructs high-dimensional embeddings from the low-dimensional embeddings that are output by the encoder layer (118). The encoder layer (118) weights and parameters may be adjusted to minimize the difference between the output of the decoder layer (119) and the input layer (117). In this way, the encoder layer (118) learns to convert the input data into a low-dimensional representation while conserving the characteristics of the input data. The auto-encoder (116) may have diverse architectures, for example, variational autoencoder, beta autoencoder, etc. Examples of frameworks, or code libraries that implement variational autoencoders and beta autoencoders are the Pythae framework in Python, and ProteoVAE (licensed to MIT). Another implementation of a beta autoencoder is 1Konny VAE, from GitHub. In one or more embodiments, any dimensionality reducing model using unsupervised learning may be used in place of the auto-encoder.

The server computer system (110) includes a low-dimensional embedding model (120). The low-dimensional embedding model (120) is configured to include the high-dimensional embedding model (113), operably and communicably coupled with the encoder layer (118) from the trained auto-encoder (116). The low-dimensional embedding model (120) configured in this manner may be deployed to convert document chunks from the unstructured data store (126) to low-dimensional embeddings, which are subsequently stored in the vector data store (127).

The server computing system (110) includes a training application (130). The training application (130) is a collection of programs and code, configured to orchestrate workflows of populating the in-memory VDB (114) with high-dimensional embeddings, training the auto-encoder, configuring the low-dimensional embedding model (120), and populating the vector data store (127) with low-dimensional embeddings.

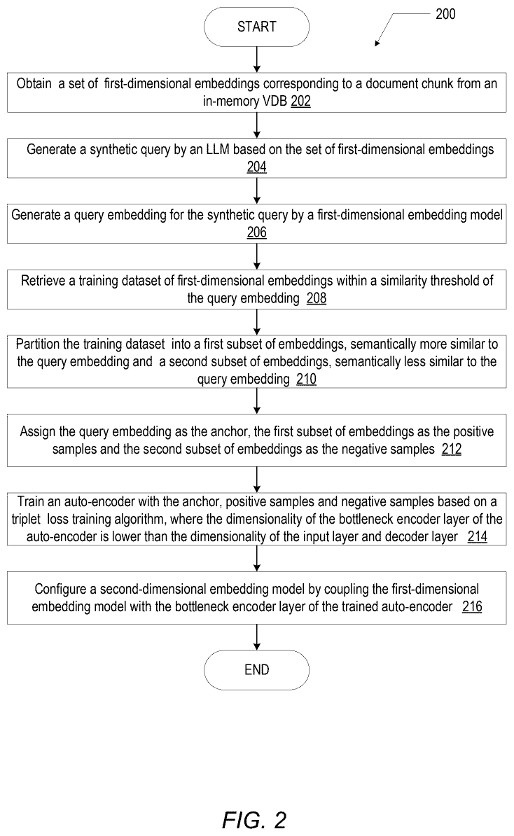

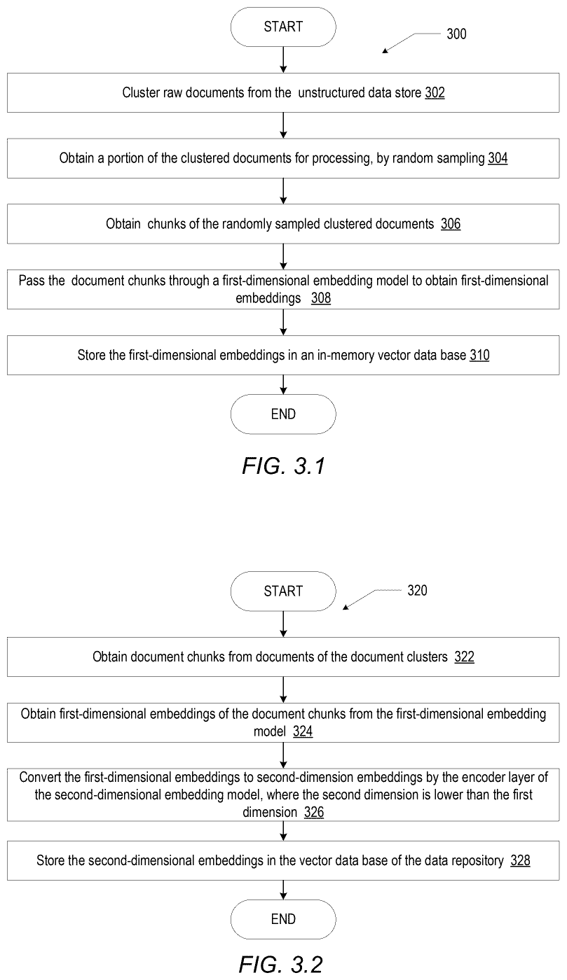

FIG. 2 shows a flowchart 200 that includes training the auto-encoder to generate low-dimensional embeddings and configuring the low-dimensional embedding model with the bottleneck layer of the trained autoencoder. More particularly, the bottleneck layer of the auto-encoder learns to generate low-dimensional embeddings from high-dimensional embeddings, while preserving the characteristics of the high-dimensional embeddings. In other words, the low-dimensional embeddings may retain or approximate the performance metrics of the high-dimensional embeddings in tasks of search, retrieval, precision, and recall, etc.

In one or more embodiments, the method of FIG. 2 may be performed when the server computing system of FIG. 1 is deployed at a production site. The method of FIG. 2 may be used to train the auto-encoder at the production site. The deployed system with the trained auto-encoder and configured low-dimensional embedding model may be used in a documentation on-boarding process, entailing the on-boarding of document corpora of the production site into the vector databases of the system of FIG. 1. Further, in a pre-processing workflow, prior to performing the method of FIG. 2, the in-memory vector database of the server computing system may be initialized. The initialization of the in-memory VDB is described in further detail in reference to the method of FIG. 3.1.

In Block 202, a set of first-dimensional embedding corresponding to a document chunk is obtained from the in-memory VDB. In one or more embodiments, the first dimension may be a high dimension, for example, 4096.

In Block 204, a synthetic query is generated by the LLM, based on the set of first-dimensional embeddings. A synthetic query refers to a machine learning model generated query, simulating a user query. The synthetic query is based on the set of first-dimensional embeddings representing the document chunk. In other words, the synthetic query is formulated as a query to which the information in the document chunk may serve as a response. For example, if the information in the document chunk is a brief description of cat breeds, the synthetic query generated may be “How many breeds of domestic cats are there? ” In one or more embodiments, the training application may provide the document chunk as a prompt input. The prompt instruction may direct the LLM to generate the synthetic query based on the document chunk, and/or the first-dimensional embeddings representing the document chunk. The first-dimensional embeddings may have a first dimension, which may be a high dimension value, e.g., 4096, etc.

In Block 206, a query embedding is generated corresponding to the synthetic query, by a first-dimensional embedding model. In one or more embodiments, the first-dimensional embedding model corresponds to the high-dimensional embedding model of the server computing system shown in FIG. 1.

In Block 208, a training dataset of first-dimensional embeddings within a similarity threshold of the query embedding is retrieved. In one or more embodiments, the training dataset of first-dimensional embeddings may be obtained from the in-memory VDB. The training dataset of first-dimensional embeddings may be within a similarity threshold of similarity to the query embedding of the synthetic query. Similarity between two embeddings may be determined by applying a similarity function, for example, cosine similarity, or any other similarity measure. The cosine similarity function may return a value between −1 and 1. A value of −1 indicates that the vectors are opposite in direction (completely dissimilar), 0 may indicate that the vectors are orthogonal (no similarity) and 1 may indicate that the vectors are identical in direction (maximum similarity). Thus, in one or more embodiments, the similarity threshold may be a pre-defined value between 0 and 1, for example, 0.85. The number of embeddings obtained may be a pre-determined number, for example, corresponding to a training dataset size, configurable in the training application.

In Block 210, the training dataset is partitioned into a first subset of first-dimensional embeddings, which are semantically more similar to the query embeddings, and a second subset of first-dimensional embeddings, which are semantically less similar to the query embedding. Notably, both the first subset of first-dimensional embeddings and the second subset of first-dimensional embeddings may have similarity score values higher than the similarity threshold. Thus, a partition cutoff point may be used to partition the embeddings into the first and second subsets. In one or more embodiments, the partition of the training dataset into the first and second subsets may be based on a median similarity score value of the training dataset, for example, 0.93. That is, the partition cutoff point used may be a median similarity score value. In certain other embodiments, the mean score value of the training dataset may be the partition cutoff point. Accordingly, the first subset of first-dimensional embeddings may be selected to each have similarity scores with respect to the query embedding that are higher than, or greater than, the partition cutoff point, which in turn may be higher than the similarity threshold. Conversely, the second subset of first-dimensional embeddings may be selected to each have similarity scores with respect to the query embedding that may be less than the partition cutoff point. In other words, the similarity scores of the second subset of first-dimensional embeddings may fall within the inclusive range defined by the partition cutoff point, and the similarity threshold.

In Block 212, the query embedding is assigned as the anchor, the first subset of embeddings are assigned as the positive samples, and the second subset of embeddings are assigned as the negative samples. The anchor is the reference input for which a meaningful representation is learned. The anchor, positive samples and negative samples are the parameters of the triplet loss training algorithm. That is, the anchor, positive samples and negative samples constitute a triplet data which is used in the triplet loss training algorithm. In the triplet loss training algorithm, the auto-encoder is trained to maximize the similarity in latent space of the first subset of embeddings (positive samples) to the anchor while minimizing the similarity (in latent space) of the second subset of embeddings (negative samples) to the anchor. Other algorithms preserving the semantics of the data may be used, for example a contrastive loss algorithm.

Accordingly, in Block 214, the auto-encoder is trained with the anchor, the positive samples and the negative samples based on the triplet loss training algorithm. A configuration of the training process may be to assign the “bottleneck” encoder layer of the auto-encoder with a lower dimensionality than the input layer and the decoder layer. To assign the lower dimensionality, in one or more embodiments, the reduction in dimensionality may be set by developers via the training application, or as a configuration parameter of the auto-encoder, or other means. In other embodiments, the reduction in dimensionality may be set to be at a minimum threshold reduction, for example, around 50%. In a similar manner, a maximum reduction level, for example, around 75%, may be set. Accordingly, in one or more embodiments, the auto-encoder, including an input layer, a “bottleneck” encoder layer, and a decoder layer is trained with the training dataset to obtain the trained auto-encoder.

In one or more embodiments, training the auto-encoder may entail performing operations including selecting the first subset of first-dimensional embeddings from the training dataset. The operations may further include selecting the second subset of first-dimensional embeddings from the training dataset. Further, the query embedding may be selected as an anchor embedding. The first subset, the second subset, and the anchor embedding may be the parameters of a triplet loss function. Further, a first first-dimensional embedding from the first subset of first-dimensional embeddings may be selected as a positive sample. The positive sample may be processed by the auto-encoder, through the bottleneck encoder layer to obtain a second-dimensional embedding. Further, a positive sample output may be reconstructed by the decoder layer of the auto-encoder, from the second-dimensional embedding. The positive sample output may be a second first-dimensional embedding. Furthermore, a triplet loss function is calculated. The triplet loss function minimizes a semantic distance between the positive sample output and the anchor embedding. The triplet loss function is backpropagated through the decoder later, and the bottleneck encoder layer to update parameters of the auto-encoder.

In a similar manner, a first first-dimensional embedding may be selected from the second subset of first-dimensional embeddings as a negative sample. The auto-encoder may process the negative sample through the bottleneck encoder layer to obtain a second-dimensional embedding. Further, the decoder layer of the auto-encoder may reconstruct a negative sample output from the second-dimensional embedding. The negative sample output is a second first-dimensional embedding. Furthermore, the triplet loss function may be calculated. The triplet loss function maximizes a semantic distance between the negative sample output and an anchor embedding. The triplet loss function is then backpropagated through the decoder layer, and the bottleneck encoder layer to update parameters of the auto-encoder.

In Block 216, the second-dimensional embedding model is configured with the first-dimensional embedding model coupled with the “bottleneck” encoder layer of the trained auto-encoder. The second-dimensional embedding model corresponds to the low-dimensional embedding model shown in FIG. 1. In other words, subsequent to the completion of training the auto-encoder, the encoder layer of the auto-encoder may be coupled with the high-dimensional embedding model of the server computing system to configure the low-dimensional embedding model. In one or more embodiments, the output of the first-dimensional embedding model may be connected to the input of the bottleneck encoder layer, to obtain the configured second-dimensional embedding model. Further, the second dimension is lower (in magnitude) than the first dimension. In one or more embodiments, a dimension reduction value for the auto-encoder (i.e., the i.e.erence in magnitude between the first and second dimension) may be configured in the auto-encoder, prior to training the auto-encoder. The dimension reduction value may be based on a user preference comprising metrics for accuracy, latency, and cost. For example, in one case, the user preference may be to reduce the dimensions by 50%, as the performance with respect to accuracy may be desirable to preserve. In another case, the user preference may be to reduce the dimensions by 75%, to reduce latency and cost.

Turning now to FIG. 3.1, flowchart 300 shows a method for creating first-dimensional embeddings for the auto-encoder. More particularly, the first-dimensional embeddings are created for training the auto-encoder to learn to convert the first-dimensional embeddings to second-dimensional embeddings. The second dimension is lower than the first dimension, in some embodiments, reduced by at least 50%. In one or more embodiments, a raw document may be obtained from a document store in a data repository. Further, the first-dimensional embedding model may generate a multitude of first-dimensional embeddings of a multitude of document chunks of the raw document. The first-dimensional embeddings may be stored in the in-memory vector database.

Accordingly, in Block 302, a multitude of raw documents from the unstructured data store are clustered. In one or more embodiments, the raw documents may be clustered using the clustering model to obtain clusters of the raw documents. In Block 304, a subset of the raw documents may be selected from the clusters of raw documents. The selection of the subset of raw documents may be based on a random sampling function. The random sampling function effectively downsizes the generation of high-dimensional, computationally expensive embeddings for the documents. For example, the random sampling function may select a subset of raw documents from the clusters of documents. In one or more embodiments, the random sampling function may downsize the clusters of raw documents to the selected subset of raw documents, such that the cardinality of the selected subset of raw documents is between 1% and 5% of a count of raw documents of the multitude of raw documents.

In Block 306, chunks of the randomly sampled clustered data are obtained. In Block 308, the first-dimensional embedding model processes the chunks to obtain corresponding first-dimensional embeddings. In Block 310, the high-dimensional embeddings are stored in the in-memory VDB.

FIG. 3.2 shows a flowchart 320 of a method for generating low-dimensional embeddings for unstructured documents. In one or more embodiments, the steps of flowchart 320 may be performed by the low-dimensional embedding model of FIG. 1. In one or more embodiments, the low-dimensional embedding model may be configured subsequent to the performance of the steps of flowchart 200 and flowchart 300. That is, the server computing system deployed at the production site, now with a trained auto-encoder and a configured low-dimensional embedding model, may on-board the document corpora of the production site into the vector database.

In Block 322, document chunks are obtained from documents of the document clusters. In one or more embodiments, a multitude of document chunks may be obtained from a multitude of raw documents (of the document clusters). The multitude of document chunks may include multi-modal data, for example, text, images, audio/video, etc.

In one or more embodiments, the multitude of document chunks may be converted to a corresponding multitude of second-dimensional embeddings by the configured second-dimensional embedding model. The configured second-dimensional embedding model corresponds to the low-dimensional embedding model of FIG. 1. Accordingly, in Block 324, first-dimensional embeddings of the document chunks are obtained from the first-dimensional embedding model that is a sub-component of the configured second-dimensional embedding model. In one or more embodiments, the first-dimensional embeddings may be intermediate or temporary values and may utilize computational resources for a temporary period. Further, the computational load on the server computing system may be impacted for the temporary period and subsequently eased. In Block 326, the first-dimensional embeddings are converted to second-dimensional embeddings by the “bottleneck” encoder layer of the configured second-dimensional embedding model. In one or more embodiments, the bottleneck encoder layer of the second-dimensional embedding model is obtained from the trained auto-encoder. In Block 328, the multitude of second-dimensional embeddings are stored in the vector database of the data repository.

The steps of the flowchart 320 may be performed for the documents in the unstructured data store. In this manner, the vector database in the data repository may be populated with second-dimensional embeddings corresponding to documents of the unstructured data store. The vector database may be further used for document search and retrieval when deployed in the RAG framework of the server computer system.

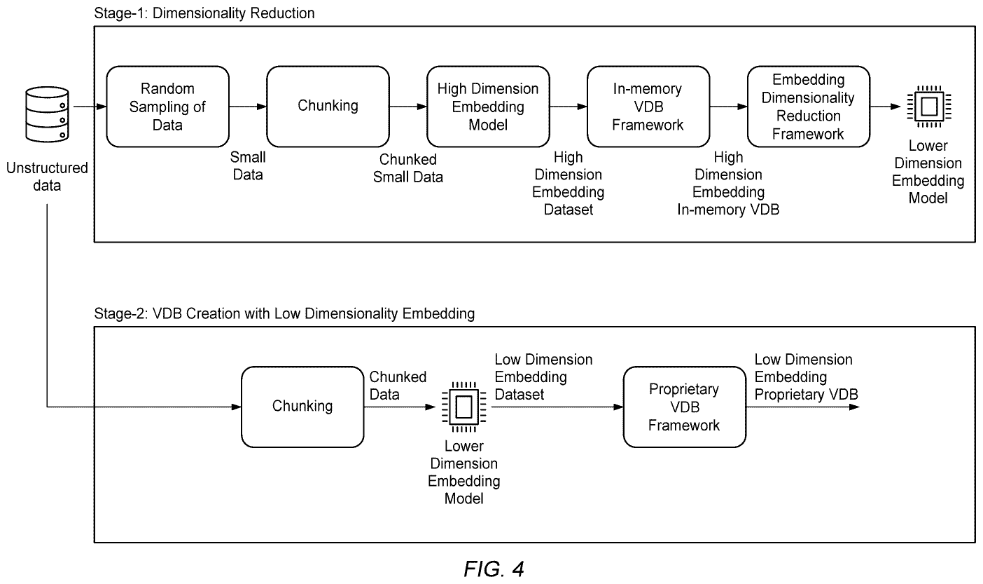

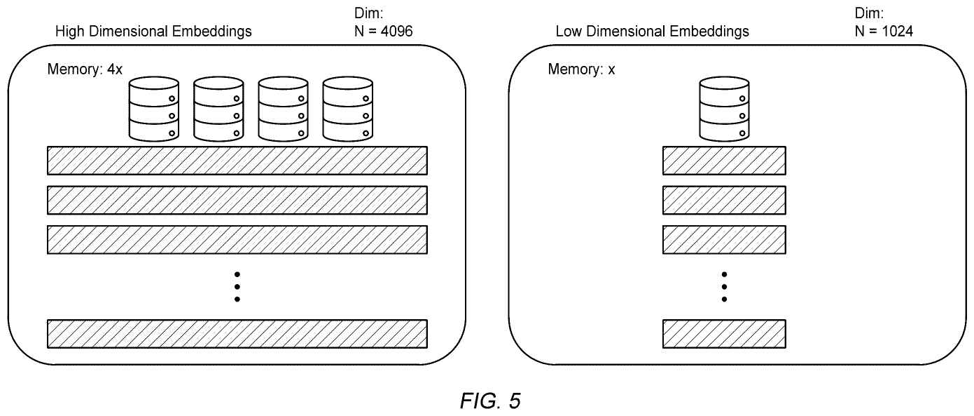

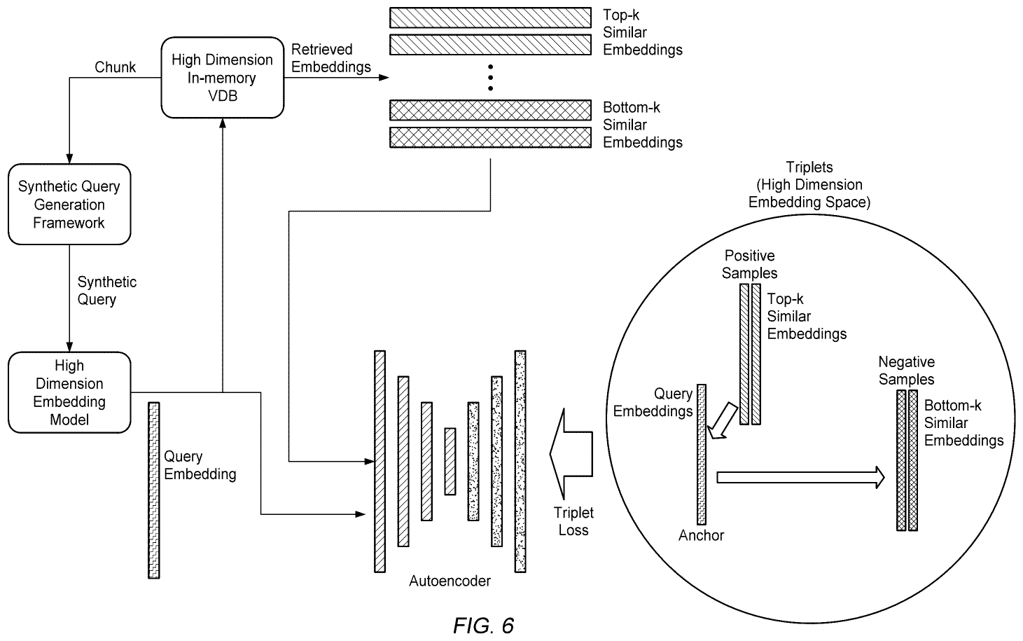

FIG. 4 shows a diagram of a two-stage workflow of dimensionality reduction of embeddings. In the first stage, dimensionality reduction of original high-dimensionality embedding is performed by developing a Machine Learning (ML)/Deep Learning (DL) model. For a given large volume of unstructured data, a fraction of the data, for example, 1% data is used for the dimensionality reduction process. The selection of data can be done by a clustering algorithm. The data may be clustered using K-means clustering. The number of clusters may be determined, for example, using the elbow method. The sample per cluster may be sampled randomly to select a dataset.

The percentage of samples sampled from the unstructured data may be varied depending upon the training performance in the second stage. The randomly selected (for example, a sample size of 1% of the unstructured data) data is chunked. The chunks are then passed through the high-dimension embedding model to obtain a high-dimensional embedding dataset (e.g. 4096 dimensionality). The embeddings of the selected data are stored in an in-memory VDB. Using the in-memory VDB saves the cost of a large number of embedding retrievals during the embedding dimensionality reduction process. The final step involves training an auto-encoder model for embedding dimensionality reduction which uses data from the in-memory VDB for training. The outcome of the first stage is the lower dimension embedding model (e.g., 1024 dimensionality).

In the second stage, the data is chunked and passed through the lower dimension embedding model obtained from the first stage. The low-dimensional embeddings for the data chunks are obtained. The low-dimensional embeddings are stored in a vector data store for downstream RAG application. Flowcharts 300 (FIG. 3.1) and 200 (FIG. 2) correspond to the steps performed to complete the workflow shown in the first stage of FIG. 4. Flowchart 320 of FIG. 3.2 corresponds to the steps performed to complete the workflow shown in the second stage of FIG. 4, namely, vector database creation with low dimensionality embedding.

FIG. 5 shows an illustrative example of storage requirements for high and low-dimensional embeddings. Memory storage increases linearly with the dimension of the embeddings. Furthermore, latency increases with the embedding dimension. Low-dimensional embeddings have lower in-memory cost and offer lower latency (for embedding retrieval in RAG application) while, simultaneously retaining performance scores. If the dimension is 4096, the memory requirement is four times the memory requirement for storing embeddings of dimensionality 1024. Thus, FIG. 5 shows a linear increase of in-memory requirement as dimensionality increases.

The workflow shown in FIG. 6 corresponds to the flowchart 200 of FIG. 2 and to the block labeled “Embedding dimensionality reduction framework” of FIG. 4. FIG. 6 shows the methodology to reduce the dimensionality of embeddings. A chunk is sampled from an in-memory VDB (first stage of end-to-end workflow of FIG. 4). The text chunk is passed to a synthetic query generation framework. The synthetic query generation framework may use an LLM or other Natural Language Processing (NLP) model to generate a synthetic query/question based on the text chunk. The synthetic query is passed through a high-dimensional embedding model (e.g., 4096 dimensionality) to obtain the query embedding. LLM-based query generation generates diversity in the training dataset. However, in certain cases, instead of generating a query, the embedding for a chunk may be considered as the anchor sample, thereby saving the cost on LLM-based consumption and latency in the training process for dimensionality reduction.

Based on the similarity to the query embedding, “P” number of embeddings are retrieved from the in-memory VDB. Top-k (2*k<=P) embeddings correspond to the text chunks which are semantically similar to a synthetic query. Bottom-k embeddings correspond to the text chunks which are semantically less similar to the synthetic query.

Using the query embedding as an anchor point, top-k embeddings are positive samples, and bottom-k embeddings are negative samples, an auto-encoder is trained using triplet loss. The input and output of the auto-encoder has dimensionality which is the same as high-dimensional embeddings (e.g., 4096). The bottleneck layer of the auto-encoder may have a dimension which is lower than the input and output dimensions (e.g., 1024). The auto-encoder may be trained unsupervised. Diverse techniques may be used to train the auto-encoder. Recommendations may be made to developers on optimal embedding dimensions from a cost, performance, and latency perspective.

Subsequent to the completion of the training of the auto-encoder, in the second stage as shown in FIG. 7, the low-dimensional embedding model is configured by coupling the high-dimensional embedding model output to the input of the encoder of the trained auto-encoder. Low-dimensional embeddings are obtained by passing the text chunk initially through a high-dimensional embedding model to obtain high-dimensional embeddings. The high-dimensional embedding is input to the encoder of the trained auto-encoder shown in FIG. 7. The encoder converts the high-dimensional embeddings to low-dimensional embeddings.

Dimensionality reduction of the embedding may be carried out in an unsupervised manner without requiring any manual intervention. When new unstructured data becomes available, the system may be invoked automatically, and reduced dimension embeddings may be generated and stored in VDB. Although embedding dimension is reduced, the new embeddings preserve the semantics in the data which is at least as good as the older high dimensional embeddings. Lower dimension embeddings facilitate faster latency and lower memory requirements for storage and retrieval of embeddings. The reduced dimension embeddings may yield similar performance results for RAG application as higher dimension embeddings, with lower cost for embedding storage.

Using the system, users/customers may customize the RAG-based LLM applications based on their requirements for latency, accuracy, and cost by deciding on the extent of reduction of dimension of embeddings to be used in the RAG application. Recommendations for optimal embedding size can be made to users for the embedding size for optimal performance in terms of cost, latency, and performance of RAG-based LLM application.

Embodiments may be implemented on a computing system specifically designed to achieve an improved technological result. When implemented in a computing system, the features and elements of the disclosure provides a technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 8.1, the computing system (800) may include one or more computer processors (802), non-persistent storage (804), persistent storage (806), a communication interface (808) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) may be one or more cores or micro-cores of a processor. The computer processor(s) (802) includes one or more processors. The one or more processors may include a central processing unit (CPU), a graphics processing unit (GPU), a tensor processing unit(s)(TPU), combinations thereof, etc.

The input devices (810) may include a touchscreen, keyboard, mouse, microphone, touchpad, electronic pen, or any other type of input device. The input devices (810) may receive inputs from a user that are responsive to data and messages presented by the output devices (812). The inputs may include text input, audio input, video input, etc., which may be processed and transmitted by the computing system (800) in accordance with the disclosure. The communication interface (808) may include an integrated circuit for connecting the computing system (800) to a network (not shown) (e.g., a local area network (LAN), a wide area network (WAN) such as the Internet, mobile network, or any other type of network) and/or to another device, such as another computing device.

Further, the output devices (812) may include a display device, a printer, external storage, or any other output device. One or more of the output devices may be the same or different from the input device(s). The input and output device(s) may be locally or remotely connected to the computer processor(s) (802). Many different types of computing systems exist, and the aforementioned input and output device(s) may take other forms. The output devices (812) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (800) in FIG. 8.1 may be connected to or be a part of a network. For example, as shown in FIG. 8.2, the network (820) may include multiple nodes (e.g., node X (822), node Y (824)). Each node may correspond to a computing system, such as the computing system shown in FIG. 8.1, or a group of nodes combined may correspond to the computing system shown in FIG. 8.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822), node Y (824)) in the network (820) may be configured to provide services for a client device (826), including receiving requests and transmitting responses to the client device (826). For example, the nodes may be part of a cloud computing system. The client device (826) may be a computing system, such as the computing system shown in FIG. 8.1. Further, the client device (826) may include and/or perform all or a portion of one or more embodiments.

The computing system of FIG. 8.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method, comprising:
generating, by a large language model (LLM) a synthetic query based on a set of first-dimensional embeddings having a first dimension;
generating, by a first-dimensional embedding model, a query embedding corresponding to the synthetic query;
retrieving a training dataset of first-dimensional embeddings, wherein the training dataset of first-dimensional embeddings is within a similarity threshold of the query embedding;
training an auto-encoder comprising an input layer, a bottleneck encoder layer, and a decoder layer with the training dataset to obtain a trained auto-encoder; and
configuring a second-dimensional embedding model to comprise the first-dimensional embedding model and the bottleneck encoder layer, wherein an output of the first-dimensional embedding model is connected to an input of the bottleneck encoder layer, to obtain a configured second-dimensional embedding model that generates second-dimensional embeddings having a second dimension, wherein the second dimension is lower than the first dimension.

2. The method of claim 1, further comprising:
obtaining a plurality of document chunks from a plurality of raw documents, wherein the plurality of document chunks comprises multi-modal data;
converting the plurality of document chunks to a corresponding plurality of second-dimensional embeddings by the configured second-dimensional embedding model; and
storing the corresponding plurality of second-dimensional embeddings in a vector database.

3. The method of claim 1, further comprising:
obtaining a plurality of raw documents from a document store in a data repository;
clustering the plurality of raw documents using a clustering model to obtain clusters of raw documents;
selecting a subset of raw documents from the clusters of raw documents, based on a random sampling function, wherein a cardinality of the subset of raw documents is between 1% and 5% of a count of raw documents of the plurality of raw documents.
generating, by the first-dimensional embedding model, a plurality of first-dimensional embeddings of a plurality of document chunks of the raw document; and
storing the first-dimensional embeddings in an in-memory vector database.

4. The method of claim 1, further comprising:
selecting a first subset of first-dimensional embeddings from the training dataset of first-dimensional embeddings, wherein the first subset of high-dimensional embeddings each have similarity scores with respect to the query embedding greater than a partition cutoff point of the training dataset.

5. The method of claim 1, further comprising:
selecting a second subset of first-dimensional embeddings from the training dataset of first-dimensional embeddings, wherein the second subset of first-dimensional embeddings each have similarity scores with respect to the query embedding less than a partition cutoff point of the training dataset.

6. The method of claim 1, further comprising:
training the auto-encoder by performing operations comprising:
selecting a first subset of first-dimensional embeddings from the training dataset,
selecting a second subset of first-dimensional embeddings from the training dataset, and
selecting the query embedding as an anchor embedding, as parameters of a triplet loss function.

7. The method of claim 1, further comprising:
training the auto-encoder by performing operations comprising:
selecting a first first-dimensional embedding from a first subset of first-dimensional embeddings as a positive sample,
processing, by the auto-encoder, the positive sample through the bottleneck encoder layer to obtain a second-dimensional embedding, and
reconstructing, by the decoder layer of the auto-encoder, a positive sample output from the second-dimensional embedding, wherein the positive sample output is a second first-dimensional embedding.

8. The method of claim 7, further comprising:
calculating a triplet loss function, wherein the triplet loss function minimizes a semantic distance between the positive sample output and an anchor embedding, and
backpropagating the triplet loss function through the decoder layer, and the bottleneck encoder layer to update parameters of the auto-encoder.

9. The method of claim 1, further comprising:
training the auto-encoder by performing operations comprising:
selecting a first first-dimensional embedding from a second subset of high-dimensional embeddings as a negative sample,
processing, by the auto-encoder, the negative sample through the bottleneck encoder layer and the bottleneck encoder layer to obtain a second-dimensional embedding, and
reconstructing, by the decoder layer of the auto-encoder, a negative sample output from the second-dimensional embedding, wherein the negative sample output is a second first-dimensional embedding.

10. The method of claim 9, further comprising:
calculating a triplet loss function, wherein the triplet loss function maximizes a semantic distance between the negative sample output and an anchor embedding, and
backpropagating the triplet loss function through the decoder layer, and the bottleneck encoder layer to update parameters of the auto-encoder.

11. The method of claim 1, further comprising:
configuring, based on a user preference comprising metrics for accuracy, latency, and cost, a dimension reduction value for the auto-encoder, prior to training the auto-encoder.

12. A system, comprising:
at least one computer processor;
an LLM, executing on the at least one computer processor;
an auto-encoder, executing on the at least one computer processor;
a first-dimensional embedding model, executing on the at least one computer processor;
a second-dimensional embedding model, executing on the at least one computer processor; and
a training application, executing on the at least one computer processor, and configured for:
causing the LLM to generate a synthetic query based on a set of first-dimensional
embeddings having a first dimension,
causing the first-dimensional embedding model to generate a query embedding corresponding to the synthetic query,
retrieving a training dataset of first-dimensional embeddings, wherein the training dataset of first-dimensional embeddings is within a similarity threshold of the query embedding,
training an auto-encoder comprising an input layer, a bottleneck encoder layer, and a decoder layer with the training dataset to obtain a trained auto-encoder, and
configuring a second-dimensional embedding model to comprise the first-dimensional embedding model and the bottleneck encoder layer, wherein an output of the first-dimensional embedding model is connected to an input of the bottleneck encoder layer, to obtain a configured second-dimensional embedding model, wherein a second dimension is lower than a first dimension.

13. The system of claim 12, further configured for:
obtaining a plurality of document chunks from a plurality of raw documents;
converting the plurality of document chunks to a corresponding plurality of second-dimensional embeddings by the configured second-dimensional embedding model; and
storing the corresponding plurality of second-dimensional embeddings in a vector database.

14. The system of claim 12, wherein the training application is further configured for:
obtaining a plurality of raw documents from a document store in a data repository;
clustering the plurality of raw documents using a clustering model to obtain clusters of raw documents;
selecting a subset of raw documents from the clusters of raw documents, based on a random sampling function, wherein a cardinality of the subset of raw documents is between 1% and 5% of a count of raw documents of the plurality of raw documents.
generating, by the first-dimensional embedding model, a plurality of first-dimensional embeddings of a plurality of document chunks of the raw document; and
storing the first-dimensional embeddings in an in-memory vector database.

15. The system of claim 12, wherein the training application is further configured for:
selecting a first subset of first-dimensional embeddings from the training dataset of first-dimensional embeddings, wherein the first subset of high-dimensional embeddings each have similarity scores with respect to the query embedding greater than a partition cutoff point of the training dataset, and
selecting a second subset of first-dimensional embeddings from the training dataset of first-dimensional embeddings, wherein the second subset of first-dimensional embeddings each have similarity scores with respect to the query embedding less than a partition cutoff point of the training dataset.

16. The system of claim 12, wherein the training application is further configured for:
selecting a first subset of first-dimensional embeddings from the training dataset,
selecting a second subset of first-dimensional embeddings from the training dataset,
selecting the query embedding as an anchor embedding, as parameters of a triplet loss function.

17. The system of claim 15, wherein the training application is further configured for:
selecting a first first-dimensional embedding from the first subset of first-dimensional embeddings as a positive sample,
causing the auto-encoder to process the positive sample through the bottleneck encoder layer to obtain a second-dimensional embedding, causing the auto-encoder to reconstruct, by the decoder layer of the auto-encoder, a positive sample output from the second-dimensional embedding, wherein the positive sample output is a second first-dimensional embedding,
calculating a triplet loss function, wherein the triplet loss function minimizes a semantic distance between the positive sample output and an anchor embedding, and
backpropagating the triplet loss function through the decoder layer, and the bottleneck encoder layer to update parameters of the auto-encoder.

18. The system of claim 15, wherein the training application is further configured for:
selecting a first first-dimensional embedding from a second subset of high-dimensional embeddings as a negative sample,
causing the auto-encoder to process the negative sample through the bottleneck encoder layer and the bottleneck encoder layer to obtain a second-dimensional embedding,
causing the auto-encoder to reconstruct, by the decoder layer of the auto-encoder, a negative sample output from the second-dimensional embedding, wherein the negative sample output is a second first-dimensional embedding,
calculating a triplet loss function, wherein the triplet loss function maximizes a semantic distance between the negative sample output and an anchor embedding, and
backpropagating the triplet loss function through the decoder layer, and the bottleneck encoder layer to update parameters of the auto-encoder.

19. The system of claim 12, wherein a dimension reduction value is configured for the auto-encoder based on a user preference, prior to training the auto-encoder.

20. A non-transitory computer-readable medium storing instructions that, when executed by at least one computer processor, cause the at least one computer processor to perform operations comprising:
generating, by a large language model (LLM) a synthetic query based on a set of first-dimensional embeddings having a first dimension;
generating, by a first-dimensional embedding model, a query embedding corresponding to the synthetic query;
retrieving a training dataset of first-dimensional embeddings, wherein the training dataset of first-dimensional embeddings is within a similarity threshold of the query embedding;
training an auto-encoder comprising an input layer, a bottleneck encoder layer, and a decoder layer with the training dataset to obtain a trained auto-encoder; and
configuring a second-dimensional embedding model to comprise the first-dimensional embedding model and the bottleneck encoder layer, wherein an output of the first-dimensional embedding model is connected to an input of the bottleneck encoder layer, to obtain a configured second-dimensional embedding model that generates second-dimensional embeddings having a second dimension, wherein the second dimension is lower than the first dimension.
